(19) United States
(12) Patent Application Publication
(10) Pub. No.: US 2026/0184951 A1
(43) Pub. Date: Jul. 2, 2026

(54) MICROBE RESISTANT PAINT COMPOSITION

(71) Applicant: Rohm and Haas Company, Collegeville, PA (US)

(72) Inventors: Tara L. Conley, Chalfont, PA (US); Erica A. Frankel, Audubon, PA (US); Sipei Zhang, Royersford, PA (US); Arnold S. Brownell, Lansdale, PA (US)

(21) Appl. No.: 19/129,833

(22) PCT Filed: Dec. 7, 2023
(86) PCT No.: PCT/US2023/082805

§ 371 Date: May 14, 2025

Related U.S. Application Data
(60) Provisional application No. 63/432,523, filed on Dec. 14, 2022.

(51) Int. Cl. C09D 133/08; C09D 5/02; C09D 7/63

(52) U.S. Cl. CPC C09D 133/08; C09D 5/024; C09D 7/63

(57) ABSTRACT

The present invention relates to a formulated paint composition containing preservative amounts of a C₄-C₁₀-alkyl hydroperoxide and a method for preparing the paint.

### BACKGROUND OF THE INVENTION

The present invention relates to a paint composition that is resistant to microbial growth even in the absence of a biocide.

Paints are preserved with antimicrobial agents to inhibit the formation and growth of biological organisms such as bacteria, yeast, and mold while in storage. Inhibition of these organisms prevents product degradation and spoilage, as well as off-gassing of volatile products and consequent pressure build-up in closed containment. Preservation is therefore essential for reasons of health, safety, and performance.

In-can preservatives such as isothiazolinones are facing intense regulatory scrutiny for their real or perceived adverse impact on health, safety, and the environment; in fact, an outright ban of these biocides in many parts of the world appears likely. Inasmuch as the development of new biocides is unlikely for reasons of cost and a widespread perception, justified or not, of their inherent dangers, a need exists to supplant biocides with alternative non-biocidal preservatives that are safer and more sustainable.

A recent example of a non-biocidal approach for preserving paints against microbial contamination can be found in EP 3 456 787 B1, which discloses a water-borne coating formulation adjusted to a pH in the range of 10 to 12.5. While ostensibly effective, these very high pH formulations create additional safety and health concerns that render this approach impractical. Other non-traditional approaches such as the addition of silver or zinc ions may adversely affect the properties of the paint and face regulatory scrutiny as well. For these reasons, other safer and more sustainable approaches for preserving paints, and materials that are used in paints, are needed.

### SUMMARY OF THE INVENTION

The present invention addresses a need in the art by providing a composition comprising a mixture of a formulated paint and from 40 ppm to 1000 ppm of a C₄-C₁₀-alkyl hydroperoxide.

The composition of the present invention provides a paint that is resistant to microbial growth even in the absence of a biocide.

### DETAILED DESCRIPTION OF THE INVENTION

The present invention is a paint composition comprising a mixture of a formulated paint and from 40 ppm to 1000 ppm of a C₄-C₁₀-alkyl hydroperoxide.

Formulated paints can be conveniently prepared by combining a letdown portion, which is a mixture of an aqueous dispersion of polymer particles (i.e., a latex), a thickener, a defoamer, a surfactant, a neutralizer, and water with a grind portion, which is a blend of an opacifying pigment such as TiO₂, an extender pigment, a defoamer, a neutralizer, a dispersant, and water. In one aspect of the invention, the latex preferably contains from 100 ppm to 2500 ppm of a C₄-C₁₀-alkyl hydroperoxide, and the concentration of the C₄-C₁₀-alkyl hydroperoxide in the finally formulated paint arises solely from the amounts of this additive in the latex. Alternatively, the desired concentration of the C₄-C₁₀-alkyl hydroperoxide can be achieved by addition of this additive to both the latex and the finally formulated paint.

The concentration of the C₄-C₁₀-alkyl hydroperoxide in the latex is preferably in the range of from 60 or from 100 ppm or from 125 ppm or from 150 ppm or from 175 ppm or from 225 ppm or from 275 ppm or from 350 ppm, to preferably 900 ppm or to 750 ppm or to 600 ppm or to 500 ppm. Preferably, the t-C₄-C₁₀-alkyl hydroperoxide is t-butyl hydroperoxide (t-BHP) or t-amyl hydroperoxide (t-AHP), and the concentration of the t-C₄-C₁₀-alkyl hydroperoxide in the latex is determined using NMR spectroscopy as detailed in the experimental section.

The formulated paint also preferably contains less than a preservative amount of a biocide, which means that the paint contains less than an amount of biocide required to pass a challenge test as defined herein. Preferably, the formulated paint contains no biocide.

It has been surprisingly discovered that paints can be preserved by merely including a preservative amount of a t-C₄-C₁₀-alkyl hydroperoxide in a latex used to formulate the paints.

### Examples

NMR Spectroscopic Determination of t-AHP or t-BHP in Serum Phase

A 10-mL polycarbonate tube was charged with 3.0 mL of a latex sample, 3.0 mL of Milli-Q water, and centrifuged at 100,000 rpm for 15 min. The resulting clear supernatant was decanted and transferred into a 5-mm NMR tube. A flame-sealed capillary tube filled with an external standard (5.00 wt % d₄-sodium trimethylsilylpropionate in D₂O) was added to the NMR tube. Careful attention was paid to proper alignment of the external standard within the NMR tube. NMR spectra were obtained using the Bruker AVANCE III 600 spectrometer equipped with a 5-mm BroadBand CryoProbe. Each sample was tuned and shimmed individually but pulse widths and receiver gain were held constant for a sample series. Concentration of free t-amyl hydroperoxide was measured by using the zg pulse sequence with the following parameters: acquisition time (aq)=2.5 s, recycle delay (d1)=30 s, number of transients (ns)=1024, receiver gain (rg)=32, and pulsewidth (p1)=11 ms. All other parameters (time domain size, sweep width, dwell time, pre-scan delay, and carrier frequency) were left at the default values. Concentration of free hydroperoxide was calculated by comparing the integrations of peaks resonating around 1.2 ppm and the peak for the external standard at 0.0 ppm. Spectra were referenced to the external standard at 0.0 ppm on the trimethylsilyl chemical shift scale. The purity of the resonances ascribed to hydroperoxides were unambiguously confirmed with a ¹H-¹³C heteronuclear multiple bond coherence (HMBC) experiment using the hmbcgplpndqf pulse sequence. Integral normalization was estimated by using a diffusion-ordered spectroscopy (DOSY) experiment using the ledbpgp2s pulse sequence to determine the weighted average mass of the SSS oligomers.

### Preparation of Samples for Microbial Resistance

Samples were tested for microbial resistance “as-is” (not heat-aged) as well as after being subjected to 50° C. for four-weeks (heat-aged). A 10-g aliquot was taken from each sample and inoculated three times at 7-d intervals with 10⁶-10⁷ colony forming units per milliliter of sample (CFU/mL) of a standard pool of bacteria, yeasts, and molds obtained from American Type Culture Collection (ATCC) that are common contaminants in coatings. Once inoculated, the samples were stored in 25° C. incubators. Test samples were monitored for microbial contamination by agar plating using a standard streak plate method. Samples were plated 1 d and 7 d after each microbial challenge onto trypticase soy agar (TSA) and potato dextrose agar (PDA) plates. All agar plates were checked daily up to 7 d after plating to determine the number of microorganisms surviving in the test samples. Between checks, the agar plates were stored in incubators at 30° C. for TSA plates and at 25° C. for PDA plates. The extent of microbial contamination was established by counting the colonies, where the rating score was determined from the number of microbial colonies observed on the agar plates. Reported results come from day 7 readings, and are summarized for both the “as-is” and heat-aged samples. Results are described by the rating score for each type of microorganism: B=bacteria, Y=yeast, and M=mold. For example, a 3B describes a plate with 3 rating score for bacteria, or a Tr Y (1) describes a plate with trace yeast (1 colony on plate). Table 1 illustrates the rating system used to estimate the level of microbial contamination on streak plates. Colonies refers to the number of colonies on the plate.

TABLE 1
Rating system for estimating microbial contamination

| Colonies | Rating Score | Contamination | Result |
|---|---|---|---|
| None | 0 | None | Pass |
| 1-9 | Tr | Trace | Pass |
| 10 to 99 | 1 | Very Light | Fail |
| 100 to ~1000 | 2 | Light | Fail |
| ~1000 to 10,000 | 3 | Moderate | Fail |
| >10,000 | 4 | Heavy | Fail |

In Table 1, “Pass” means fewer than ten colonies were detected on plates on the specified day (Day 1 (D1) or Day 7 (D7)) after inoculation. “Fail means that ten or more distinct colonies were detected on plates on the specified day after inoculation.

Table 2 illustrates the components used to prepare the formulated paints. Latex 1 refers to a phosphoethyl methacrylate (PEM) functionalized acrylic latex (47.2% solids) containing 466 ppm of t-AHP and no biocide; Latex 2 refers to a PEM-functionalized acrylic latex (50 weight percent solids) containing <100 ppm of t-AHP and 220 ppm of a Kordek MLX In-can Preservative. Latex 3 refers to a styrene-acrylic latex (50.1 weight percent solids) containing 536 ppm of t-AHP and no biocide; and Latex 4 refers to a styrene-acrylic latex (41.5 weight percent solids) containing <100 ppm t-AHP, and 48 ppm of Kathon LX Biocide.

TABLE 2
Paint Formulations

| Ingredients (pbw) | Comp. 1 | Ex. 1 | Comp. 2 | Ex. 2 |
|---|---|---|---|---|
| Water | 200.0 | 197.4 | 200.0 | 198.0 |
| Tamol 1124 Dispersant | 5.7 | | | |
| OROTAN ™ CA-2500 Dispersant | | 10.6 | 21.1 | 21.0 |
| Potassium Hydroxide (10%) | 4.0 | 3.9 | | |
| AMP-95 Neutralizer | | | 2.5 | 2.5 |
| DOWSIL ™ 71 Defoamer | 1.0 | 1.0 | 1.0 | 1.0 |
| TRITON ™ DF-16 Surfactant | 2.0 | 2.0 | 2.0 | 2.0 |
| Ti-Pure R-706 Titanium Dioxide | 150.2 | 148.3 | 200.3 | 198.3 |
| Omycarb 3 CaCO₃ | 135.2 | 133.4 | 90.1 | 89.2 |
| Omyacarb 8 CaCO₃ | | | 270.4 | 267.7 |
| Latex 1 | | 389.1 | | |
| Latex 2 | 385.6 | | | |
| Latex 3 | | | | 322.3 |
| Latex 4 | | | 387.8 | |
| TERGITOL ™ 15-S-40 Surfactant | 2.0 | 2.0 | 2.0 | 2.0 |
| DOWSIL ™ 71 Defoamer | 1.0 | 1.0 | 1.0 | 1.0 |
| Water | 113.2 | 123.5 | 22.3 | 94.0 |
| ACRYSOL ™ TT-935 Rheology Modifier | 10.5 | | | |
| CELLOSIZE ™ QP-4400 Rheology Modifier | | | 2.5 | 4.5 |
| ACRYSOL ™ RM-2020 E Rheology Modifier | 20.0 | 19.7 | 20.0 | 19.8 |
| ACRYSOL ™ RM-725 Rheology Modifier | | 10.7 | | |
| Potassium Hydroxide (10%) (neutralizer) | 59.2 | 4.3 | | |
| Potassium Tripolyphosphate | 2.0 | 2.0 | 2.0 | 2.0 |

OROTAN, DOWSIL, TRITON, TERGITOL, DOWSIL, ACRYSOL, AND CELLOSIZE are all Trademarks of The Dow Chemical Company or its Affiliates.

TABLE 3
As-is Challenge Test Results

| Ex. No. | C1 |
|---|---|
| Ex. 1 | Pass |
| Comp. 1 | Fail |
| Ex. 2 | Pass |
| Comp. 2 | Fail |

The comparative paints, which contained preservative levels of biocide in the latex used to make these paints failed the first challenge test. In contrast, the paints containing preservative levels of t-AHP in the latex used to make the example paints passed the first challenge test. Moreover, the Example 1 paint passed two challenge tests while the Example 2 paint passed all three challenge tests.

1. A composition comprising a mixture of a formulated paint and from 40 ppm to 1000 ppm of a C₄-C₁₀-alkyl hydroperoxide.

2. The composition of claim 1 which comprises from 60 ppm to 900 ppm of a C₄-C₁₀-alkyl hydroperoxide.

3. The composition of claim 1 which comprises from 100 ppm to 750 ppm of a C₄-C₁₀-alkyl hydroperoxide, wherein the C₄-C₁₀-alkyl hydroperoxide is t-butyl hydroperoxide or t-amyl hydroperoxide.

4. The composition of claim 3 which comprises from 100 ppm to 500 ppm or t-butyl hydroperoxide or t-amyl hydroperoxide.

5. The composition of claim 1 which comprises less than a preservative amount of a biocide.

6. A method for preparing a paint comprising the step of mixing an acrylic or styrene-acrylic latex with water, an opacifying pigment, a rheology modifier, a surfactant, a defoamer, a neutralizer, optionally a dispersant, and optionally an extender, wherein the acrylic or styrene-acrylic latex contains from 100 ppm to 2500 ppm of a C₄-C₁₀-alkyl hydroperoxide, and the amount of the latex mixed with the other components is in the range of from 10 to 25 weight percent, based on the weight of all components use to prepare the paint.

7. The method of claim 6 wherein the C₄-C₁₀-alkyl hydroperoxide is t-butyl hydroperoxide or t-amyl hydroperoxide, and the paint is prepared by mixing the acrylic or styrene-acrylic latex with water, an opacifying pigment, a rheology modifier, a surfactant, a defoamer, a neutralizer,
a dispersant, and an extender.

8. The method of claim 7 wherein the components other than the latex do not contain any C₄-C₁₀-alkyl hydroperoxide.

9. The method of claim 1 wherein less than a preservative amount of a biocide is used to prepare the paint.
